(19) United States
(12) Patent Application Publication
(10) Pub. No.: US 2019/0367035 A1
(43) Pub. Date: Dec. 5, 2019

(54) CONTROL METHOD AND CONTROL UNIT FOR A DRIVETRAIN

(71) Applicant: ZF Friedrichshafen AG, Friedrichshafen (DE)

(72) Inventors: Christian MITTELBERGER, Ravensburg (DE); Stefan BLATTNER, Ravensburg (DE); Kai BORNTRÄGER, Langenargen (DE); Johannes GLÜCKLER, Eriskrich (DE); Markus EISELE, Friedrichshafen (DE)

(21) Appl. No.: 16/407,583

(22) Filed: May 9, 2019

(30) Foreign Application Priority Data
Jun. 4, 2018 (DE) 10 2018 208 760.1

(51) Int. Cl. B60W 30/192; B60W 20/15; B60K 26/04; B60W 10/115

(52) U.S. Cl. CPC B60W 30/192; B60W 20/15; B60K 2702/06; B60W 10/115; B60K 26/04

(57) ABSTRACT

A method for operating a drive-train having two drives, a drive output, a manual transmission having a planetary gearset and two independent load paths. From the first and second drives, torque can pass to the output via respective first and second paths. The two drives can be coupled to respective elements of the planetary gearset, and the transmission is coupled to a web gear. To start, when torque passes to the output first via a second path gear and thereafter via a first path gear whose ratio is different from that of the second path gear, then before changing from the second path to the first path, the torque passed at the web gear is changed such that if torque desired by the driver is unchanged, despite the change from the second to the first path, the torque acting at the output remains constant.

This application claims priority from German patent application serial no. 10 2018 208 760.1 filed Jun. 4 2018.

### FIELD OF THE INVENTION

The invention relates to a method for operating a drive-train. In addition the invention relates to a control unit for operating a drive-train.

### BACKGROUND OF THE INVENTION

DE 10 2015 221 490 A1 describes a drive-train of a motor vehicle having a manual transmission in the form of a power-branched transmission, a planetary gearset, a plurality of drive sources and a drive output. The manual transmission in the form of a power-branched transmission, which is also called the main transmission, provides two load paths, namely a first load path with at least two shiftable gears and a second load path also with at least two shiftable gears. A first drive source, in particular in the form of an internal combustion engine, can deliver drive torque to the drive output at least by way of the first load path of the manual transmission. A second drive source in the form of an electric machine can deliver drive torque to the drive output at least by way of the second load path of the manual transmission, which is independent of the first load path. The two drive sources and the manual transmission are coupled to the elements of the planetary gearset namely to the elements ring gear, web and sun gear. In this case the manual transmission is coupled to the web of the planetary gearset. The electric machine is coupled to another element of the planetary gearset, in particular to the sun gear. The internal combustion engine can be coupled to yet another element of the planetary gearset, in particular to the ring gear.

In the manual transmission in the form of a power-branched transmission, called the main transmission, gears for the two drive sources can be engaged independently of one another. These gears can have different gear ratios. When, in order to start, torque is transmitted to the drive output first by way of the second load path in a gear of the second load path and after that by way of the first load path in one of the gears of the first load path with a different gear ratio, the torque acting at the drive output can change, which is perceived by the driver as uncomfortable. This is a disadvantage.

### SUMMARY OF THE INVENTION

Starting from there, the purpose of the present invention is to provide a new type of method for operating a drive-train and a control unit for operating a drive-train. This objective is achieved by a method for operating a drive-train according to the independent claim(s). According to the invention, when, in order to start, torque is transmitted to the drive output first by way of the second load path in a gear of the second load path and after that by way of the first load path in a gear of the first load path with a different gear ratio, before a change from the second load path to the first load path the torque applied at the web of the planetary gearset is changed in such manner that with an unchanged driver's desired torque, notwithstanding the change from the second load path to the first load path the torque at the drive output remains constant or approximately constant. By virtue of the invention, it can be ensured that during starting, when a change between the load paths takes place with gears having gear ratios that differ from one another, the torque acting at the drive output remains constant or approximately so. This then corresponds to the driving behavior expected and desired by the driver. Accordingly, the driving comfort can be increased thereby.

The torque desired by the driver can for example be characterized by the accelerator pedal position of a motor vehicle equipped with the drive-train previously described. The above-mentioned starting refers to a starting process of the motor vehicle equipped with the drive-train.

If during starting the gear used in the first load path has a lower gear ratio than the gear used in the second load path, the torque applied at the web of the planetary gearset is reduced in such manner that during and after the change from the second load path to the first load path, when there is no change in the torque desired by the driver, the torque acting at the drive output remains constant or approximately constant during and after the change of load path. In contrast, if during starting the gear used in the first load path has a higher gear ratio than the gear used in the second load path, the torque applied at the web is increased in such manner that during and after the change from the second load path to the first load path, when there is no change in the torque desired by the driver, the torque acting at the drive output remains constant or approximately constant during and after the change of the load path. With both variants, depending on what the size ratio of the gear ratios of the two gears of the two load paths used for starting is, a comfortable starting process can be achieved.

A function in accordance with which the torque applied at the web of the planetary gearset is changed, preferably depends on the gear ratios of the gears, on the driving speed or drive output rotational speed, and on the driver's wish. According to an advantageous further development, the function also depends on a road inclination and/or on a vehicle mass and/or on the charge condition of an electrical energy store. This allows a highly comfortable starting process to be achieved.

The control unit according to the invention is defined in the independent claim(s).

### BRIEF DESCRIPTION OF THE DRAWINGS

Preferred further developments emerge from the subordinate claims and the description given below. Example embodiments of then invention, to which it is not limited, are explained in greater detail with reference to the drawings, which show:

FIG. 1: A drive-train of a motor vehicle;

FIG. 2: A time diagram to clarify the invention;

FIG. 3: A further time diagram to clarify the invention.

### DETAILED DESCRIPTION OF THE PREFERRED EMBODIMENTS

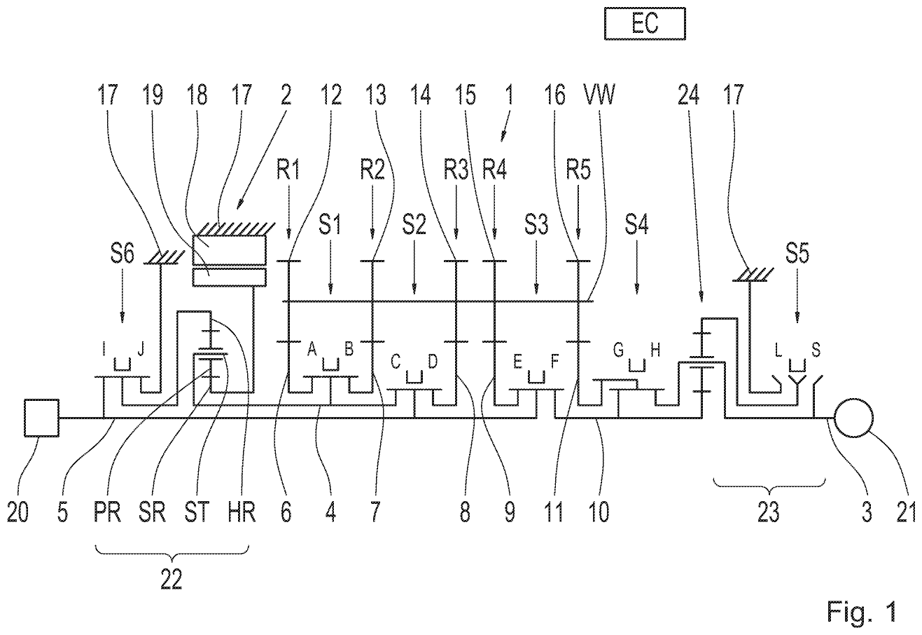

The invention relates to a method for operating a drive-train having a first drive source, a second drive source, a manual transmission designed as a power-branched transmission which provides a plurality of load paths, a planetary gearset and a drive output. FIG. 1 shows a drive-train layout of a motor vehicle with which the invention is preferably used. At this point it should be pointed out that the invention is not limited to the drive-train configuration shown in FIG. 1, but can also deviate therefrom.

The drive-train of FIG. 1 comprises a manual transmission 1 designed as a power-branched transmission. Further, the drive-train has two drive sources 2, 20, wherein a first drive source 20 is preferably in the form of an internal combustion engine and a second drive source 2 is preferably in the form of an electric machine.

The drive-train of FIG. 1 also comprises a planetary gearset 22 with the elements ring gear HR, web ST and sun gear SR and planetary gearwheels PR. In FIG. 1, a further partial transmission 23 is connected downstream from the power-branched manual transmission 1, which according to FIG. 1 comprises a further planetary gearset 24. However, this further partial transmission 23 is purely optional and without significance for the present invention.

As already explained, the manual transmission 1 is a power-branched transmission that provides a plurality of load paths. Thus, the power-branched manual transmission 1 has the two transmission input shafts 4 and 5 as well as a plurality of shifting packets S1, S2, S3 and S4 with the shifting elements A, B, C, D, E, F, G and H.

These shifting packets S1, S2, S3 and S4 co-operate with the gearsets R1, R2, R3, R4 and R5. The gearsets R1, R2, R3, R4 and R5 comprise the gearwheels 12, 13, 14, 15 and 16 which are arranged on a countershaft VW, and the gearwheels 6, 7, 8, 9, 11 which are arranged either on the transmission input shafts 4, 5 or on a main shaft 10 of the manual transmission 1.

FIG. 1 also shows a drive output 21, which is coupled to an output shaft 3 of the partial transmission 23.

As already explained, the manual transmission 1 designed as a power-branched transmission provides a plurality of load paths. From the first drive source in the form of an internal combustion engine, which is coupled to the transmission input shaft 5 of the manual transmission 1, drive torque can be transmitted to the drive output 21 by way of a first load path of the manual transmission 1, and in this first load path the shifting elements C, D, E and F co-operate to provide a plurality of shiftable gears for the first load path.

From the second drive source in the form of an electric machine 2, by way of a second load path of the manual transmission 1, which is independent of the first load path, drive torque can be transmitted to the drive output 21, and for this the electric machine 2 is coupled via the planetary gearset 22 to the transmission input shaft 4 of the manual transmission 1. The shifting elements A and B co-operate with this second bad path in order to enable a number of shiftable gears to be obtained for the second load path.

By means of the shifting packet S6, which comprises the shifting elements I and J, the internal combustion engine serving as the first drive source 20 can be connected into the second load path or to the transmission input shaft 4, namely when the shifting element I of the shifting packet S6 is closed. In this case the planetary gearset 22 acts as a superimposition gear system and both of the drive sources 2, 20 can deliver torque to the input shaft 4 of the manual transmission 1

In the drive-train shown in FIG. 1 the manual transmission 1, namely its input shaft 4, is coupled to the web ST of the planetary gearset 22. The electric machine 2, specifically a so-termed rotor 19 of the electric machine 2, is coupled to the sun gear SR of the planetary gearset 22. In contrast, a so-termed stator 18 of the electric machine 2 is coupled to a housing structure 17. When the shifting element I of the shifting packet 36 is closed, the ring gear HR of the planetary gearset 22 is connected to the first drive source 20. On the other hand, when the shifting element J of the shifting packet S6 is closed, the ring gear HR of the planetary gearset 22 is connected fixed to the housing.

For the sake of completeness it should be mentioned that in the drive-train of FIG. 1 the planetary gearset 24 of the partial transmission 23 co-operates with a shifting packet S5 which has the shifting elements L and S. Depending on which of the shifting elements L and S of the shifting packet S5 is closed, the ring gear HR of the planetary gearset 24 is coupled either fixed to the housing, or to the output shaft 3. As already explained, however, the partial transmission 23 with the planetary gearset 24 and the shifting packet S5 has no bearing on the present invention.

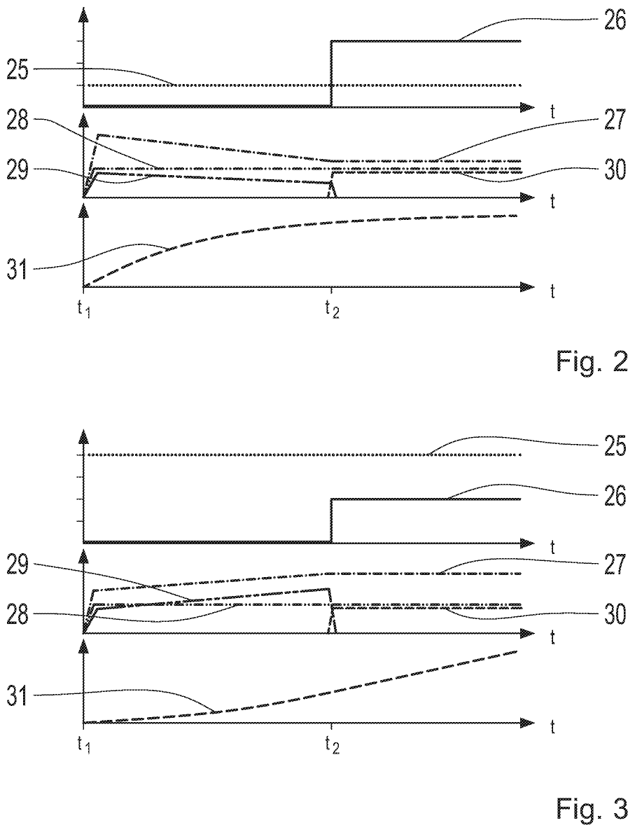

The invention relates to the starting process of a drive-train which has a first drive source, a second drive source, a manual transmission designed as a power-branched transmission and a planetary gearset, which in what follows will be described as an example with reference to the drive-train of FIG. 1 and the time diagrams of FIGS. 2 and 3. As already explained, the invention can also be used with other drive-train configurations having a power-branched transmission which provides two load paths, and a planetary gearset connected upstream from the power-branched transmission on its drive input side.

In FIGS. 2 and 3, in each case plotted against time t are shown a number of curves, namely with the curves 25 a gear engaged in the second load path, with the curves 26 a gear engaged in the first part-transmission, with the curves 27, 28, 29 and 30 torque variations, and with the curves 31 variations of a driving speed or a rotational speed of the drive output 21. In each case the curves 27 visualize a torque applied or acting at the drive output 21. The curves 28 visualize a torque desired by a driver. The curves 29 visualize an input torque at the input shaft 4 of the second load path, while the curves 30 visualize an input torque at the input shaft 5 of the first load path.

In FIG. 2 and in FIG. 3, in each case a starting process begins at time t1, in each case in that beginning at time ti drive torque is at first delivered to the drive output 21 only by a gear of the second load path, i.e. with the shifting element A closed or with the shifting element B closed. In this case the curve 25 shows that for the second load path one gear is engaged. According to the curve 26, at first no gear is yet engaged in the first load path, i.e. at time ti the shifting elements C, D, E and F are open. The torque 29 delivered for the second load path at first corresponds to the torque 28 desired by the driver. During the starting process the torque desired by the driver is constant or approximately constant.

When, beginning at time t1 starting is carried out purely electrically, in the shifting packet S6 the shifting element J adopts a closed position and the torque 29 acting at the web ST of the planetary gearset 22 depends exclusively on the torque delivered by the electric machine 2.

At this point it should be mentioned that at time ti starting can also be carried out electro-dynamically, and in that case the shifting element I of the shifting packet S6 is closed. Then, both the electric machine 2 and the internal combustion engine 20 deliver torque to the drive output 21 via the planetary gearset 22 and the input shaft 4, and accordingly by way of the second load path and the gear engaged in the second load path, with the shifting element A or the shifting element B closed. During electro-dynamic starting the planetary gearset 22 acts as a superimposition gear system.

During starting, from the second load path in which a corresponding gear is engaged, a shift should now take place to the first load path with a corresponding gear of the first load path, for which purpose, at time t2 according to the curve 26, a gear for the first load path is engaged, for example by closing the shifting element C or the shifting element D or the shifting element E or the shifting element F.

When changing from the second load path to the first load path at time t2, as shown by the curve 29 the torque applied to the transmission input shaft 4 or the torque acting on the web ST of the planetary gearset 22, i.e. the torque for the second load path, is reduced whereas in contrast, as shown by the curve 30, the torque applied to the transmission input shaft 5 for the first load path, which is delivered by the first drive source 20 in the form of the internal combustion engine, is increased, indeed up to the level of the torque 28 desired by the driver.

As already mentioned, the gears 25 and 26 of the load paths have different gear ratios.

In FIG. 2 the gear 26 of the first load path is higher, and therefore the gear ratio of the gear 26 of the first load path is lower, than in the gear 25 of the second load path.

In FIG. 3 the gear 26 of the first load path is lower, and therefore the gear ratio of the gear 26 of the first load path is higher, than in the gear 25 of the second load path.

In order, now, to start notwithstanding the change from the second load path to the first load path at time t2, while avoiding an unsteady, abrupt change of the torque 27 applied at the drive output 21, which would be perceived by the driver, before the shift from the second load path to the first load path the torque 29 applied at the web ST of the planetary gearset 22 and the input shaft 4 of the multi-step transmission 1 is changed, namely between times ti and t2, in such manner that if the torque 28 desired by the driver remains unchanged and notwithstanding the shift from the second load path to the first load path and despite the change from the gear of the second load path to the gear of the first load path, the torque 27 acting at the drive output remains constant or approximately so.

This change of the torque 29 applied at the web ST of the planetary gearset 22 or the input shaft 4 of the multi-step transmission 1 takes place during a synchronization phase of the shifting element to be closed for the first load path.

When, as shown in FIG. 2, the gear 26 engaged at time t2 for the first load path is higher than the gear 25 for the second load path and accordingly the gear 26 for the first load path has a lower gear ratio then the gear 25 for the second load path, then starting at the level of the torque 28 desired by the driver the torque 29 applied at the web ST of the planetary gearset 22 is reduced until time t2 in such manner that when shifting from the second load path to the first load path at time t2, and following the change from the second load path to the first load path after time t2, with the torque 28 desired by the driver unchanged, the torque 27 acting at the drive output remains constant or approximately constant during and after the change of load path.

When changing from the second load path to the first load path at time t2 a load transfer takes place from the second load path to the first load path. During this the input torque 29 of the second load path is eliminated completely while the input torque 30 of the first load path is increased to the torque 28 desired by the driver.

Thus, FIG. 2 shows that before time t2, i.e. before the load path change, the torque 29 acting at the web ST of the planetary gearset 22 is reduced, starting from the level of the torque 28 desired by the driver, so that when after the load path change the lower gear ratio of the first load path comes into effect the torque 27 acting at the drive output is kept constant or approximately so. In this way an unsteady change of the vehicle's speed, shown by the curve 31, is prevented.

FIG. 3 shows a version of the invention in which the gear 26 for the first load path engaged at time t2 is lower than the gear 25 for the second load path, and accordingly the gear 26 for the first load path has a higher gear ratio than the gear 25 for the second load path. In this case, before the load path change at time t2 the torque 29 applied or acting at the web ST of the planetary gearset 22 and thus at the input shaft 4 of the multi-step transmission 1, starting at the level of the torque 28 desired by the driver, is increased in such manner that when changing from the second to the first load path at time t2 and following the change from the second to the first load path at time t2 and thereafter, if the torque 28 desired by the driver is unchanged and despite the fact that the gear ratios of the gears of the two load paths are different, the torque 27 acting at the drive output remains constant or approximately so.

When changing from the second to the first load path at time t2, there again takes place a load transfer from the second load path to the first load path. During this the input torque 29 of the second load path is eliminated completely whereas the input torque 30 of the first load path is increased to the level of the torque 28 desired by the driver.

In FIGS. 2 and 3 the torque applied at the web ST of the planetary gearset 22 and thus at the input shaft 4 of the second load path before time t2 when the load path change takes place, is changed starting from the level of the torque 28 desired by the driver, in a linear or ramp-like manner. The function in accordance with which this torque applied at the web ST of the planetary gearset 22 is changed before time t2 is at least dependent on the gear ratios of the gears of the two load paths used for starting, on the driving speed or drive output rotational speed, and on the driver's wish. If necessary the function in accordance with which the torque applied at the web ST of the planetary gearset 22 and thus at the input shaft 4 of the second load path can be changed, can also depend on a road inclination, a mass of the motor vehicle, a charge condition of an electrical energy store that co-operates with the electric machine 2, and on moments of inertia.

The invention also relates to a control unit EC for operating a drive-train, which serves to carry out the method according to the invention by control means,

When, in order to start, torque is delivered to the drive output at first by way of the second load path, i.e. in FIG. 1 via the load path of the transmission input shaft 4 and one of the shifting elements A and B, in a gear of the second load path, and thereafter by way of the first load path, i.e. via the transmission input shaft 5 and one of the shifting elements C, D, E or F in a gear of the first load path which has a gear ratio different from that of the gear of the second load path, before a change from the second to the first load path the control unit EC changes the torque acting at the web ST of the planetary gearset 22 and hence at the input shaft 4 of the second load path, by first controlling at least the drive source 2 or if necessary by controlling the drive source 20 in such manner that when the second load path is changed to the first load path and after the change from the second to the first load path, if the driver's desired torque is unchanged, the torque acting at the drive output 21 remains constant or approximately constant notwithstanding the change from the second to the first load path.

When changing from the second to the first load path at time t2, a load transfer takes place from the second load path to the first load path. During this the input torque 29 of the second load path is eliminated completely and the input torque 29 of the first load path is increased.

The invention makes it possible, when the torque desired by the driver is unchanged and when despite a load path change the gear ratios of the gears involved are different, for the torque acting at the drive output 21 to remain constant or approximately constant and for the speed of the vehicle to change smoothly.

### INDEXES

1 Manual transmission
2 Drive source/electric machine
3 Output shaft
4 Input shaft
5 Input shaft
6 Gearwheel
7 Gearwheel
8 Gearwheel
9 Gearwheel
10 Main shaft
11 Gearwheel
12 Gearwheel
13 Gearwheel
14 Gearwheel
15 Gearwheel
16 Gearwheel
17 Housing structure
18 Stator
19 Rotor
20 Drive source/internal combustion engine
21 Drive output
22 Planetary gearset
23 Partial transmission
24 Planetary gearset
25 Curve/Gear of the second load path
26 Curve/Gear of the first load path
27 Curve/Drive output torque
28 Curve/Torque desired by the driver
29 Curve/Torque of the second load path
Curve/Torque of the first load path
31 Curve/Driving speed
A Shifting element
B Shifting element
C Shifting element
D Shifting element
E Shifting element
F Shifting element
G Shifting element
H Shifting element
HR Ring gear
I Shifting element
J Shifting element
L Shifting element
S Shifting element
PR Planetary gearwheel
R1 Gearset
R2 Gearset
R3 Gearset
R4 Gearset
R5 Gearset
S1 Shifting packet
S2 Shifting packet
S3 Shifting packet
S4 Shifting packet
S5 Shifting packet
S6 Shifting packet
SR Sun gear
ST Web
VW Countershaft
EC Control unit

1-10. (canceled)

11. A method of operating a drive-train having a first drive source (20), a second drive source (2), a manual transmission (1) with a planetary gearset (22) that has elements of a ring gear (HR), a web gear (ST) and a sun gear (SR), and a drive output (21), the manual transmission (1) being designed as a power-branched transmission such that: from the first drive source (20), drive torque is deliverable to the drive output (21) by way of a first load path of the manual transmission (1), the first load path having at least two shiftable gears; from the second drive source (2), at least by way of the second load path, which is independent of the first load path of the manual transmission (1), drive torque is deliverable to the drive output (21), the second load path having at least one shiftable gear; and the first drive source (20) is couplable to a first element of the planetary gearset (22), the second drive source (2) is coupled to a second element of the planetary gearset (22) and the manual transmission (1) is coupled to the web gear (ST) of the planetary gearset (22), the method comprising:
when, in order to start, delivering torque to the drive output (21) first by way of the second load path in a gear of the second load path;
thereafter delivering torque to the drive output (21) by way of the first bad path in a gear of the first load path, which has a gear ratio different from a gear ratio of the gear in the second load path; and
before a change from the second load path to the first load path, changing the torque applied at the web gear (ST) of the planetary gearset (22) such that if torque desired by a driver is unchanged and despite the change from the second load path to the first load path, the torque acting at the drive output (21) is either constant or approximately constant.

12. The method according to claim 11, further comprising providing an internal combustion engine as the first drive source (20).

13. The method according to claim 11, further comprising providing an electric machine as the second drive source (2).

14. The method according to claim 11, further comprising reducing the torque applied at the web gear (ST) of the planetary gearset (22) if, when starting, the gear used in the first load path has a lower gear ratio than the gear ratio of the gear used in the second load path such that, during and after the change from the second load path to the first bad path, if the torque desired by the driver is unchanged, the torque acting at the drive output (21) remains constant or approximately constant during and after the change from the second load path to the first load path.

15. The method according to claim 11, further comprising increasing the torque applied at the web gear (ST) of the planetary gearset (22), if, when starting, the gear used in the first bad path has a higher gear ratio than the gear ratio of the gear used in the second bad path such that, during and after the change from the second bad path to the first bad path, if the torque desired by the driver is unchanged, the torque acting at the drive output (21) remains constant or approximately constant during and after the change from the second bad path to the first bad path.

16. The method according to claim 11, further comprising changing a function in accordance with which the torque applied at the web gear (ST) of the planetary gearset (22), depending on:
the gear ratios of the gears of the first and the second load paths,
either a driving speed or a rotational speed of the drive output; and
a driver's wish.

17. The method according to claim 1$, further comprising changing the function in accordance with which the torque applied at the web gear (ST) of the planetary gearset (22) depends on at least one of a road inclination, a vehicle mass, and a charge condition of an electrical energy store.

18. The method according to claims 16, wherein the function is of a ramp-like form.

19. A control unit (EC) of a drive-train comprising:
a first drive source (20),
a second drive source (2),
a manual transmission (1),
a planetary gearset (22) having elements of a ring gear (HR), a web gear (ST) and a sun gear (SG),
a drive output (21),
the manual transmission (1) being designed as a power-branched transmission with a plurality of load paths,
from the first drive source (20) drive torque being deliverable to the drive output (21) at least by way of a first load path of the manual transmission (1), and the first load path having at least two shiftable gears,
from the second drive source (2) drive torque being delivered to the drive output (21) at least by way of a second load path of the manual transmission (1), the second load path being independent of the first load path, and the second load path having at least one shiftable gear,
the first drive source (20) being couplable to a first element of the planetary gearset (22), the second drive source (2) being coupled to a second element of the planetary gearset (22), and the manual transmission (1) being coupled to the web gear (ST) the planetary gearset (22), and
when, in order to start, drive torque is delivered to the drive output (21) by way of the second load path in a gear of the second load path and thereafter the drive torque is delivered to the drive output by way of the first load path in a gear of the first load path, a gear ratio of the gear of the first gear path is different from a gear ratio of the gear of the second load path, then before a change from the second load path to the first load path, the control unit (EC) changes the torque applied at the web gear (ST) of the planetary gearset (22) by controlling at least one of the second drive source and the first drive source such that if a torque desired by a driver is unchanged, then despite the change from the second load path to the first load path, the drive torque delivered to the drive output remains either constant or approximately constant.

20. The control unit (EC) according to claim 19, wherein the control unit is designed to carry out a method for operating the drive-train in order to start including steps of delivering torque to the drive output (21) first by way of the second load path in a gear of the second load path; thereafter delivering torque to the drive output (21) by way of the first load path in the gear of the first load path, which has the gear ratio different from the gear ratio of the gear in the second load path, and before the change from the second load path to the first load path, changing the torque applied at the web gear (ST) of the planetary gearset (22) such that if torque desired by the driver is unchanged and despite the change from the second load path to the first load path, the torque acting at the drive output (21) is either constant or approximately constant.

21. A method of operating a drive-train of a vehicle for starting the vehicle, the drive-train having first and second drive sources, a drive output, and a manual transmission having a planetary gearset that has elements of a ring gear, a web gear and a sun gear, the method comprising:
designing the manual transmission as a power-branched transmission having first and second load paths such that drive torque from the first drive source being deliverable to the drive output by the first load path, the first load path having at least first and second shiftable gears, and drive torque from the second drive source being deliverable to the drive output by the second load path, the second load path having at least a third shiftable gear and being independent of the first load path, the first drive source being couplable to a first element of the planetary gearset, the second drive source being coupled to a second element of the planetary gearset, and the manual transmission being is coupled to the web of the planetary gearset;
initially delivering the drive torque to the drive output via the third shiftable gear of the second load path;
subsequently, delivering the drive torque to the drive output via the first shiftable gear of the first load path, the first shiftable gear of the first load path having a gear ratio that is different than a gear ratio of the third shiftable gear of the second load path; and
changing drive torque applied at the web of the planetary gearset by the second load path, prior to delivering the drive torque to the drive output via the first shiftable gear of the first load path, when drive torque desired by a driver is unchanging, such that the drive torque delivered to the drive output is at least substantially constant during a change of delivering the drive torque from the second load path to the first load path.
